(19) United States
(12) Patent Application Publication
(10) Pub. No.: US 2008/0043138 A1
(43) Pub. Date: Feb. 21, 2008

(54) Digital image forming device and a digital image forming method used thereon

(75) Inventor: Jen Sheng Tsai, Lujhu Township (TW)

Correspondence Address: BIRCH STEWART KOLASCH & BIRCH, PO BOX 747, FALLS CHURCH, VA, 22040-0747, US

(73) Assignee: PREMIER IMAGE TECHNOLOGY CORPORATION

(21) Appl. No.: 11/594,182

(22) Filed: Nov. 8, 2006

(30) Foreign Application Priority Data
Aug. 18, 2006 (TW) 095130461

(51) Int. Cl. H04N 5/238

(52) U.S. Cl. 348/366

(57) ABSTRACT

A digital image forming device and a digital image forming method used thereon are provided. The digital image forming device includes a light metering device, a processor, a frequency generator, a timing generator, and a light sensor. The light metering device detects a surrounding light value and transmits it to the processor. The processor generates an illumination parameter according to the surrounding light value and transmits it to the frequency generator. The frequency generator then generates a frequency based on the illumination parameter and transmits it to the timing generator. The timing generator generates an exposure time and controls the light sensor to detect the outside light and therefore form an image.

This application claims benefit to a Taiwanese Patent Application No. 095130461 filed on Aug. 18, 2006.

### BACKGROUND OF THE INVENTION

1. Field of the Invention

The present invention relates to a digital image forming device and a digital image forming method used thereon.

2. Description of the Prior Art

With the progressing development in the digital technology, today, various types of data and information can be digitized and stored inside electronic devices such as a computer, a memory card, etc. Instead of capturing images onto a chemical film, through the use of a conventional film camera, images now can be captured by many different types of digital image forming devices, which transform the images into digital data. The examples of digital image forming devices include digital cameras, digital video camera recorders, and web cameras. Since time, light, and environment made a great influence on the quality of the images taken by the digital image forming device, having the ability to take a good quality picture in an unfavorable environment is an important feature that the digital image forming devices need to focus on.

When taking a picture under the condition where the surrounding light is insufficient, a longer exposure time or a larger quantity of incoming light is needed in order to produce a good quality image. Due to the limitations on the physical structure of the image forming device, such as the size of the camera lens and the diaphragm, a digital camera, for example, needs to have further adjustments on its image forming method or provide a special method for processing the image after it is captured, in order to produce a good quality image taken in an environment with insufficient surrounding light.

FIG. 1a is a flowchart showing how an image is formed using a traditional digital camera in an environment having insufficient surrounding light. First, in Step 81, a frequency oscillator sends a fixed frequency to a timing generator. Then, in Step 83, the timing generator controls a light sensor according to the fixed frequency to capture the outside light within a certain period of time; therefore, an image is created. Later, in Step 85, the image, which is technically a digital signal, will go through a signal amplifying process. Then finally in Step 87, the resultant amplified image signal is sent to a processor.

In the flowchart of FIG. 1a, the signal amplifying process in Step 85 is able to amplify the image signal when the image is captured in an environment having insufficient surrounding light. Without going through this signal amplifying process, the image taken without the sufficient amount of surrounding light may appear to be blurring or dark. However, after going through the signal amplifying process, the resultant image may become clearer and brighter. One of the drawbacks, however, is that the signal amplifying process may also amplify the noises (unwanted signals) exist among the image signal. As a result, the quality of the image will be largely reduced because the picture may still appear unclear due to the observable noises that are amplified by the signal amplifying process.

FIG. 1b is a flowchart showing how an image is formed using another digital camera in an environment having insufficient surrounding light. First, in Step 91, a frequency oscillator sends a fixed frequency to a timing generator. Then, in Step 93, the timing generator controls a light sensor according to the fixed frequency to capture the outside light within a certain period of time; therefore, an image is created. In Step 95, the light sensor captures the outside light again, repeating the process in Step 93; therefore, another image is created. Then, the two images, from Step 93 and Step 95, will go through an image overlaying process. In the process, the image from Step 93 will be overlaid with the image created from Step 95. Finally, in Step 97, the resultant image of the image overlaying process will be sent to a processor.

In the flowchart of FIG. 1b, executing the image overlaying process in Step 95 is able to obtain an image with higher luminance. However, such method utilized the same oscillatory frequency throughout the whole process, hence; the power consumption of the camera can not be reduced.

### SUMMARY OF THE INVENTION

It is a primary object of the present invention to provide a digital image forming device. The digital image forming device can detect the surrounding light value of the device and produce an image with high luminance.

It is another object of the present invention to provide a digital image forming device that can suppress noise signals.

It is another object of the present invention to provide a digital image forming device that can reduce the power consumption of the device.

It is another object of the present invention to provide a digital image forming method. The digital image forming method can detect the surrounding light value and produce an image with high luminance.

It is another object of the present invention to provide a digital image forming method that can suppress noise signals.

It is another object of the present invention to provide a digital image forming method that can reduce the power consumption of the system.

The digital image forming device preferably comprises a light metering device, a processor, a frequency generator, a timing generator, and a light sensor. Before an image is captured, the light metering device detects a surrounding light value of the environment and sends the surrounding light value to the processor. The processor generates an illumination parameter according to the surrounding light value and sends the illumination parameter to the frequency generator. In the preferred embodiment, the surrounding light value is ranged in three levels. The illumination parameter is selected from one of the group of 1, 1.2, and 1.5 depending on the surrounding light value. Furthermore, the illumination parameter and the surrounding light value are preferably to be in a negative correlation.

The frequency generator generates an oscillatory frequency according to the illumination parameter and sends the oscillatory frequency to the timing generator. In the preferred embodiment, the arithmetic unit inside the frequency generator performs a mathematical operation on a built-in predetermine frequency and the illumination parameter to obtain the oscillatory frequency. Then, the timing generator generates an exposure time according to the oscillatory frequency, and it controls the light sensor, which is electrically connected to the timing generator, to detect the outside light within the exposure time. An image, consequently, is created. In the preferred embodiment, the exposure time and the oscillatory frequency are in a negative correlation. The exposure time, in a different relationship, can also be the inverse of the oscillatory frequency.

The digital image forming method of the present invention mainly comprises the following steps: detecting a surrounding light value, generating an illumination parameter according to the surrounding light value, generating a corresponding oscillatory frequency according to the illumination parameter, generating an exposure time according to the oscillatory frequency, and detecting the outside light according to the exposure time to create an image. By adjusting the oscillatory frequency in response to the changes in the surrounding light value, a better quality image can be obtained. The adjustments to the oscillatory frequency will not increase the noise signals of the image. Further, when the oscillatory frequency is decreased, the power consumption of the system can be reduced.

### BRIEF DESCRIPTION OF THE DRAWINGS

FIG. 1a is a flowchart showing how an image is formed using a traditional digital camera in an environment having insufficient surrounding light;

FIG. 1b is a flowchart showing how an image is formed using another digital camera in an environment having insufficient surrounding light;

FIG. 2 is a block diagram showing the structure of the digital image forming device in accordance with one embodiment of the present invention;

FIG. 3 is a block diagram showing the structure of the digital image forming device wherein the digital image forming device comprises an analog-to-digital converter;

FIG. 4 is a block diagram showing the structure of the digital image forming device wherein the surrounding light value is ranged in three levels;

FIG. 5 is a block diagram showing the structure of the digital image forming device wherein the digital image forming device comprises a comparison circuit;

FIG. 6 is a block diagram showing the structure of the digital image forming device wherein the frequency generator of the digital image forming device comprises a divider and a predetermined frequency;

FIG. 7 is a block diagram showing the structure of the digital image forming device in accordance with another embodiment of the present invention;

FIG. 8 is a flowchart showing the steps of the digital image forming method of the present invention.

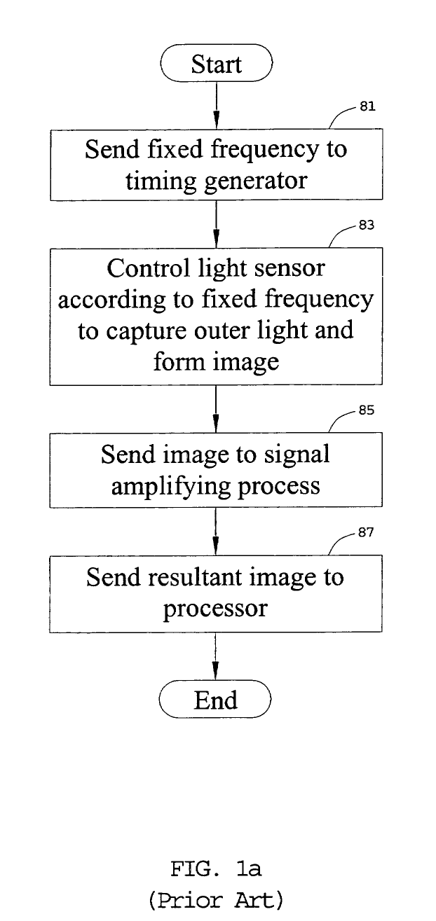

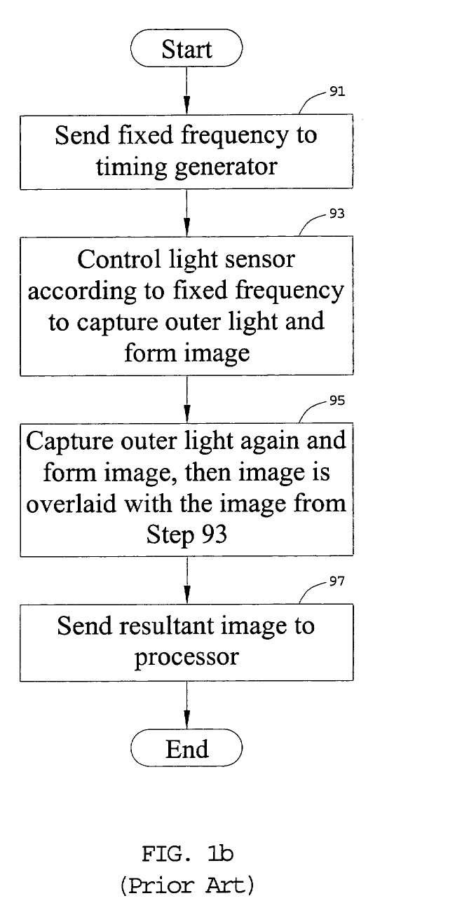

### DETAILED DESCRIPTION OF THE PREFERRED EMBODIMENT

The present invention provides a digital image forming device and a digital image forming method using the digital image forming device. In the preferred embodiment, the digital image forming device includes a digital camera. In the different embodiments, however, the digital image forming device can include a digital camera, a web camera, or any other image forming devices.

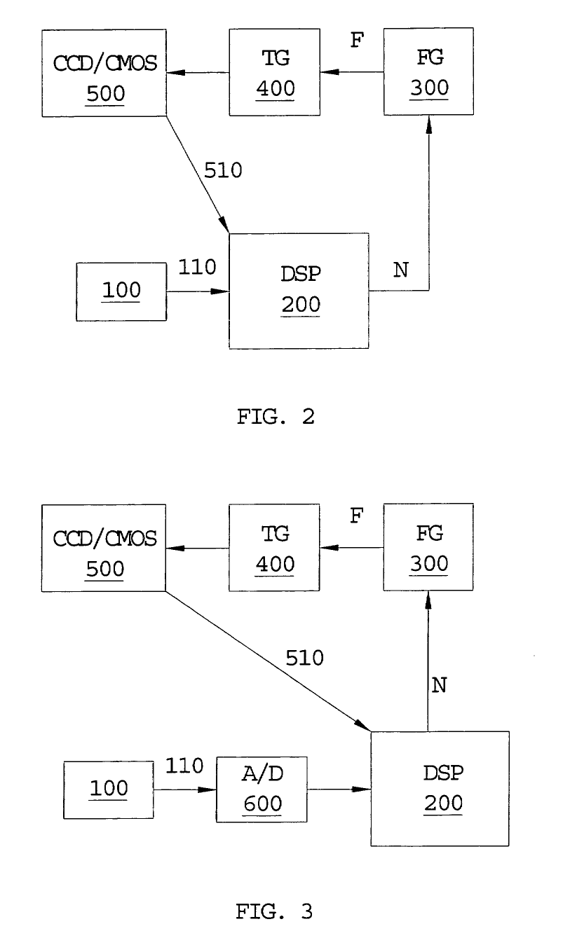

In the preferred embodiment of the digital image forming device shown in FIG. 2, the digital image forming device preferably comprises a light metering device 100, a processor 200, a frequency generator 300, a timing generator 400, and a light sensor 500. Right before the moment that an image is captured, the light metering device 100 will detect a surrounding light value (LV) 110 of the surrounding environment. The light metering device 100 is preferred to comprise a diode light detector. In a different embodiment, however, the light metering device 100 can use a light detector having a charge-coupled device (CCD) inside. In the preferred embodiment, the light metering device 100 will specifically detect the surrounding light of the main object of the image, in order to determine the surrounding light value 110. In a different embodiment, however, the light metering device 100 will detect the overall environmental light of the image to be photographed. Furthermore, the preferred light detection methods used by the light metering device 100 include a point light source detection, an area light source detection, and other similar light detection methods. In a different embodiment, however, the light metering device 100 can utilize different light detection methods to determine the surrounding light value 110.

The processor 200 is electrically connected to the light metering device 100 and receives the surrounding light value 110 from the light metering device 100. The processor 200 is preferred to comprise a digital signal processor (DSP). In the preferred embodiment, as shown in FIG. 3, the surrounding light value 110 from the light metering device 100 will be sent to an analog-to-digital converter 600 for converting its analog signal into a digital signal. Then, the converted signal will be sent to the processor 200. In a different embodiment, however, the surrounding light value 110 from the light metering device 100 can be sent to the processor 200 directly.

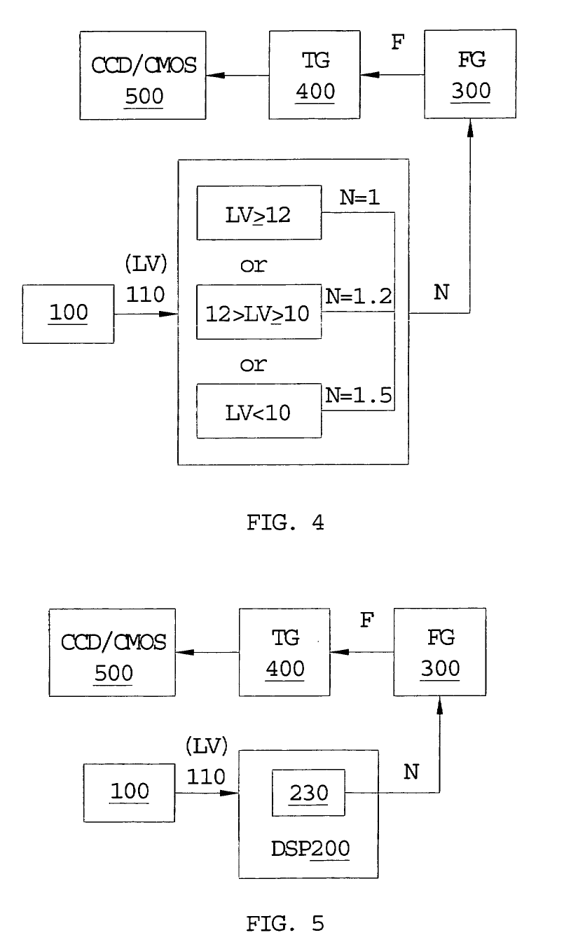

The processor 200 generates an illumination parameter N according to the received surrounding light value 110. In the preferred embodiment, as shown in FIG. 4, the surrounding light value 110 is ranged in three levels, and the illumination parameter N is selected from one of the group of 1, 1.2, and 1.5 depending on the surrounding light value 110. Further, it is preferable for the illumination parameter N and the surrounding light value 110 to be in a negative correlation. In the embodiment shown in FIG. 4, the surrounding light value 110 is obtained from the light metering device 100 by using a reflective metering method. This metering method measures the light reflected by the viewed image to be photographed, and the amount of the reflected light measured is the surrounding light value 110. When the surrounding light value 110 is greater than or equal to 12, the illumination parameter N will be 1. When the surrounding light value 110 is less than 12 and greater than or equal to 10, the illumination parameter N will be 1.2. When the surrounding light value 110 is less than 10, the illumination parameter N will be 1.5. In a different embodiment, the surrounding light value 110 is also ranged in three levels and is also obtained by using the reflective metering method. However, a different set of ranges is used in determining the corresponding illumination parameter N. When the surrounding light value 110 is greater than or equal to 15, the illumination parameter N will be 0.8. When the surrounding light value 110 is less than 15 and greater than or equal to 13, the illumination parameter N will be 1. When the surrounding light value 110 is less than 13, the illumination parameter N will be 1.2. In a different embodiment, however, the number of levels of the surrounding light value 110, the way of scaling the range of the light value in each level, as well as the corresponding values of the illumination parameter N can be varied or adjusted due to the electrical characteristics and the design of the different processor used in the embodiment.

In the embodiment of FIG. 5, another way of determining the value of the illumination parameter N is shown, which is achieved by a data comparison method. In the embodiment, there is a comparison circuit 230 built inside the processor 200. The comparison circuit 230 contains a presetting data or curve that describes the corresponding relationship between the surrounding light value 110 and the illumination parameter N. When the surrounding light value 110 is sent to the processor 200, the illumination parameter N can be obtained from the comparison circuit 230 using method such as data comparison, interpolation, etc. In a different embodiment, the comparison circuit 230 can have a built-in arithmetic unit. When the surrounding light value 110 is sent to the processor 200, the corresponding illumination parameter N can be obtained via the use of this arithmetic unit.

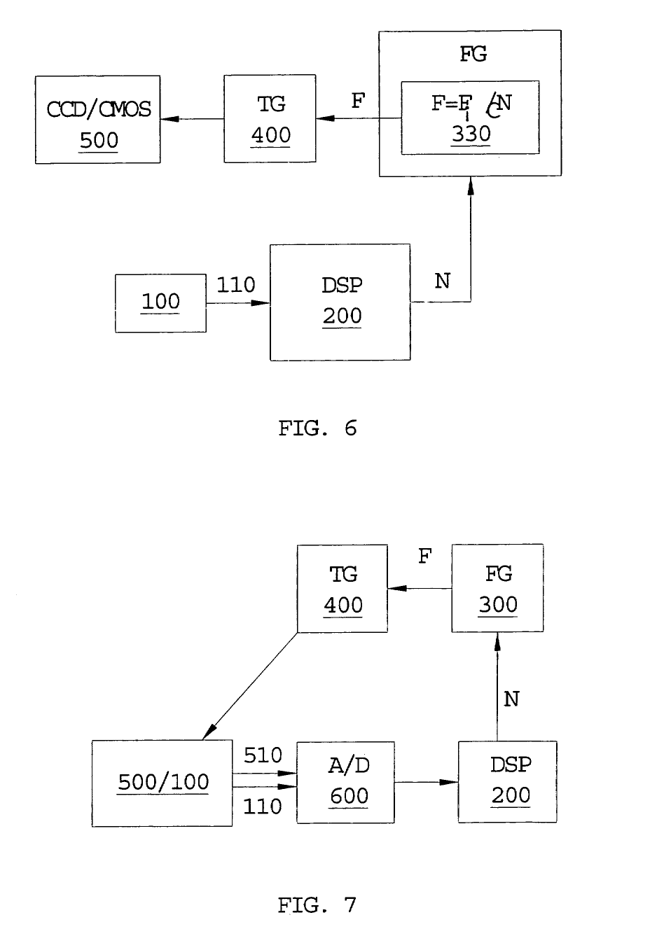

As shown in FIG. 2, the frequency generator 300 is electrically connected to the processor 200, in which the frequency generator 300 receives the illumination parameter N from the processor 200. In the preferred embodiment, the frequency generator 300 comprises a variable frequency oscillator. The frequency generator 300 generates an oscillatory frequency F corresponding to the illumination parameter N received from the processor 200. In the embodiment shown in FIG. 6, the frequency generator 300 comprises a divider 330 and a predetermined frequency F₀. The divider 330 performs a division on the predetermined frequency F₀ and the received illumination parameter N. For instance, the oscillatory frequency F is obtained from dividing the predetermined frequency F₀ by the illumination parameter N. In the preferred embodiment, when the predetermined frequency F₀ of pixel clock is 67.5 MHz, the corresponding frame rate will be 30 frames/sec. In another embodiment, when the predetermined frequency F₀ of pixel clock is changed to 54 MHz, the corresponding frame rate will be 24 frames/sec. In a different embodiment, however, the value of the predetermined frequency F₀ can be adjusted in order to accommodate to the different designs in the frequency generator 300. Furthermore, in another embodiment, the divider 330 of the frequency generator 300 can be replaced by an arithmetic unit that performs a different mathematical operation. Hence, the oscillatory frequency F can be obtained by performing the mathematical operation on the illumination parameter N and the predetermined frequency F₀ using the new arithmetic unit.

In a different embodiment, the oscillatory frequency F can be obtained by using the data comparison method. The frequency generator 300 can contain a presetting data or curve that describes the corresponding relationship between the oscillatory frequency F and the illumination parameter N. When the illumination parameter N is sent to the frequency generator 300, the oscillatory frequency F can be obtained from the frequency generator 300 using method such as data comparison, interpolation, etc.

As shown in FIG. 2, the timing generator 400 is electrically connected to the frequency generator 300, in which the timing generator 400 receives the oscillatory frequency F from the frequency generator 300. Then, the timing generator 400 will generate an exposure time according to the oscillatory frequency F. In the embodiment shown in FIG. 2, the exposure time and the oscillatory frequency F are in a negative correlation. For instance, the exposure time can be the inverse of the oscillatory frequency F or can be inversely proportional to the oscillatory frequency F. The timing generator 400 is also connected to the light sensor 500. Furthermore, the timing generator 400 controls the light sensor 500, according to the oscillatory frequency F, to detect the outside light within the exposure time. As a result, an image 510 is formed. In other words, the timing generator 400 generates the exposure time according to the oscillatory frequency F, and this exposure time is the amount of time that the light sensor 500 exposes to the outside environment while capturing the image. In the preferred embodiment, the light sensor 500 comprises a charge-coupled device (CCD). In a different embodiment, however, the light sensor 500 can comprise a complementary metal oxide semiconductor device (CMOS).

In the preferred embodiment, the processor 200 is able to determine the illumination parameter N from the surrounding light value 110 provided by the light metering device 100. Then, the illumination parameter N will be sent to the frequency generator 300 to adjust the value of the oscillatory frequency F generated by the frequency generator 300. When the surrounding light value 110 is a normal value, there will be no further adjustment to the value of the oscillatory frequency F. However, when the surrounding light value 110 is darker, the oscillatory frequency F will also decrease. When the oscillatory frequency F is lower, the light sensor 500 can obtain a longer exposure time. This satisfies the need for a larger quantity of incoming light in a situation where an image is being captured in an environment with insufficient surrounding light. As a result, in this embodiment, the captured image is able to have a higher luminance within the darker surrounding light. Furthermore, unlike the image forming method used by the traditional digital camera, the captured image will not go through a signal amplifying process, hence the noise signals of the image will not be amplified. In addition, when the oscillatory frequency F decreases, the power consumption of the digital image forming device will also decrease, which achieves a power-saving effect.

In the embodiment shown in FIG. 7, the light sensor 500 is electrically connected to the processor 200, and it sends the captured image 510 to the processor 200. In the preferred embodiment, the image 510 captured by the light sensor 500 will be sent to the analog-to-digital converter 600 for converting its analog signal into a digital signal. Then, the converted image signal will be sent to the processor 200. In a different embodiment, however, the image 510 from the light sensor 500 can be sent directly into the processor 200. Furthermore, in this embodiment, the light sensor 500 can also perform the functions of the light metering device 100, which are detecting the surrounding light value 110 and sending the detected surrounding light value 110 to the processor 200.

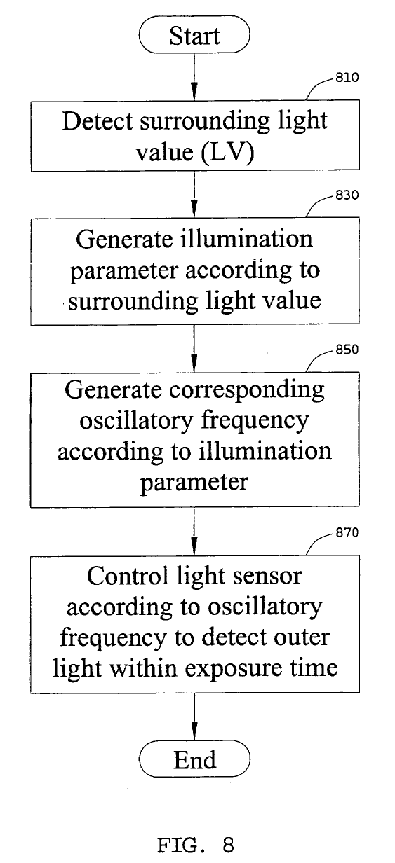

FIG. 8 is a flowchart showing the steps of a digital image forming method of the present invention. As shown in FIG. 8, Step 810 comprises detecting a surrounding light value (LV) 110. In the preferred embodiment, in Step 810, a light metering device 100 is used for detecting the surrounding light of the outside environment. The detecting method used by the light metering device 100 for detecting the surrounding light value 110 preferably comprises a point light source detection, an area light source detection, etc. In a different embodiment, however, the light metering device 100 can utilize different light detection methods to determine the surrounding light value 110.

Step 830 comprises generating an illumination parameter N according to the surrounding light value 110. In the preferred embodiment, the surrounding light value 110 is ranged in three levels, and the illumination parameter N is selected from one of the group of 1, 1.2, and 1.5 depending on the surrounding light value 110. Further, it is preferable for the illumination parameter N and the surrounding light value 110 to be in a negative correlation. In this embodiment, the surrounding light value 110 is obtained from the light metering device 100 by using a reflective metering method. This metering method measures the light reflected by the viewed image to be photographed, and the amount of the reflected light measured is the surrounding light value 110. When the surrounding light value 110 is greater than or equal to 12, the illumination parameter N will be 1. When the surrounding light value 110 is less than 12 and greater than or equal to 10, the illumination parameter N will be 1.2. When the surrounding light value 110 is less than 10, the illumination parameter N will be 1.5. In a different embodiment, the surrounding light value 110 is also ranged in three levels and is also obtained by using the reflective metering method. However, a different set of ranges is used in determining the corresponding illumination parameter N. When the surrounding light value 110 is greater than or equal to 15, the illumination parameter N will be 0.8. When the surrounding light value 100 is less than 15 and greater than or equal to 13, the illumination parameter N will be 1. When the surrounding light value 110 is less than 13, the illumination parameter N will be 1.2. In a different embodiment, however, the number of levels of the surrounding light value 110, the way of scaling the range of the light value in each level, as well as the corresponding values of the illumination parameter N can be varied or adjusted due to the electrical characteristics and the design of the different processor used in the embodiment.

In a different embodiment, the illumination parameter N can be determined by using a data comparison method. Inside a processor 200, there is a built-in or stored comparison circuit 230. The comparison circuit 230 contains a presetting data or curve that describes the corresponding relationship between the surrounding light value 110 and the illumination parameter N. When the surrounding light value 110 is sent to the processor 200, the illumination parameter N can be obtained from the comparison circuit 230 using method such as data comparison, interpolation, etc. In a different embodiment, the comparison circuit 230 can have a built-in arithmetic unit. When the surrounding light value 110 is sent to the processor 200, the corresponding illumination parameter N can be obtained via the use of this arithmetic unit.

Step 850 comprises generating a corresponding oscillatory frequency F according to the illumination parameter N. In the preferred embodiment, a frequency generator 300 is used to generate the oscillatory frequency F, and the frequency generator 300 comprises a divider 330 and a predetermined frequency F₀. The divider 330 performs a division on the predetermined frequency F₀ and the received illumination parameter N. For instance, the oscillatory frequency F is obtained from dividing the predetermined frequency F₀ by the illumination parameter N. In the preferred embodiment, when the predetermined frequency F₀ of pixel clock is 67.5 MHz, the corresponding frame rate will be 30 frames/sec. In another embodiment, when the predetermined frequency F₀ is changed to 54 MHz, the corresponding frame rate will be 24 frames/sec. In a different embodiment, however, the value of the predetermined frequency F₀ can be adjusted in order to accommodate to the different designs in the frequency generator 300. Furthermore, in another embodiment, the divider 330 of the frequency generator 300 can be replaced by an arithmetic unit that performs a different mathematical operation. Hence, the oscillatory frequency F can be obtained by performing the mathematical operation on the illumination parameter N and the predetermined frequency F₀ using the new arithmetic unit.

In a different embodiment, the oscillatory frequency F can be obtained by using the data comparison method. The frequency generator 300 can contain a presetting data or curve that describes the corresponding relationship between the oscillatory frequency F and the illumination parameter N. When the illumination parameter N is sent to the frequency generator 300, the oscillatory frequency F can be obtained from the frequency generator 300 using method such as data comparison, interpolation, etc.

Step 870 comprises controlling a light sensor 500 according to the oscillatory frequency F to detect the outside light within an exposure time for creating an image 510. In the preferred embodiment, the exposure time and the oscillatory frequency F are in a negative correlation. For instance, the exposure time can be the inverse of the oscillatory frequency F or can be inversely proportional to the oscillatory frequency F. In the system of the digital image forming method, a timing generator 400 is used to control the exposure time. Furthermore, the light sensor 500, which is electrically connected to the timing generator 400, is controlled by the timing generator 400 for detecting the surrounding light of the outside environment within the exposure time to create the image 510. In other words, the timing generator 400 generates the exposure time according to the oscillatory frequency F, and this exposure time is the amount of time that the light sensor 500 exposes to the outside environment while capturing the image.

In the preferred embodiment shown in FIG. 8, the light metering device 100 is used for providing the surrounding light value 110 in order to determine the illumination parameter N. Then, the illumination parameter N will be sent to the frequency generator 300 to adjust the value of the oscillatory frequency F generated by the frequency generator 300. When the surrounding light value 110 is a normal value, there will be no further adjustment to the value of the oscillatory frequency F. However, when the surrounding light value 110 is darker, the oscillatory frequency F will also decrease. When the oscillatory frequency F is lower, the light sensor 500 can obtain a longer exposure time. This satisfies the need for a larger quantity of incoming light in a situation where an image is being captured in an environment with insufficient surrounding light. As a result, in this embodiment, the captured image is able to have a higher luminance. Furthermore, unlike the image forming method used by the traditional digital camera, the captured image will not go through a signal amplifying process. Hence, the noise signals of the image will not be amplified. In addition, when the oscillatory frequency F decreases, the power consumption of the whole system will also decrease, which achieves a power-saving effect.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

We claim:

1. A digital image forming device, comprising:
a light metering device for detecting a surrounding light value;
a processor electrically connected to said light metering device, wherein said processor receives said surrounding light value from said light metering device and generates an illumination parameter according to said surrounding light value;
a frequency generator electrically connected to said processor, wherein said frequency generator receives said illumination parameter from said processor and generates an oscillatory frequency according to said illumination parameter;
a timing generator electrically connected to said frequency generator, wherein said timing generator receives said oscillatory frequency from said frequency generator; and
a light sensor electrically connected to said timing generator, wherein said timing generator controls said light sensor according to said oscillatory frequency to detect outside light within an exposure time for creating an image.

2. The digital image forming device according to claim 1, wherein said frequency generator includes a divider and a predetermined frequency, and said divider performs division on said predetermined frequency and said illumination parameter received from said processor to obtain said oscillatory frequency.

3. The digital image forming device according to claim 2, wherein said predetermined frequency is 67.5 MHz.

4. The digital image forming device according to claim 2, wherein said illumination parameter is selected from one of the group of 1, 1.2, and 1.5 depending on said surrounding light value.

5. The digital image forming device according to claim 1, wherein said illumination parameter and said surrounding light value are in a negative correlation.

6. The digital image forming device according to claim 1, wherein said processor includes a comparison circuit, and said comparison circuit compares said surrounding light value to obtain said illumination parameter.

7. The digital image forming device according to claim 1, wherein said light sensor is electrically connected to said processor and transfers said image to said processor.

8. The digital image forming device according to claim 1, wherein said light sensor includes a charge-coupled device (CCD).

9. The digital image forming device according to claim 1, wherein said light sensor includes a complementary metal oxide semiconductor device (CMOS).

10. A method for forming a digital image, comprising:
detecting a surrounding light value;
generating an oscillatory frequency according to said surrounding light value, and
controlling a light sensor according to said oscillatory frequency to detect outside light within an exposure time for creating an image.

11. The method for forming a digital image according to claim 10, wherein said step of generating said oscillatory frequency includes performing a division on a predetermined frequency and said illumination parameter to obtain an oscillatory frequency.

12. The method for forming a digital image according to claim 11. wherein said predetermined frequency is 67.5 MHz

13. The method for forming a digital image according to claim 10, wherein said step of generating said oscillatory frequency further includes:
generating an illumination parameter according to said surrounding light value; and
generating said oscillatory frequency according to said illumination parameter

14. The method for forming a digital image according to claim 13, wherein said step of generating said illumination parameter includes determining said illumination parameter by selecting from one of the group of 1, 1.2, and 1.5 depending on said surrounding light value.

15. The method for forming a digital image according to claim 13, wherein said step of generating said illumination parameter includes comparing said surrounding light value using a comparison circuit to obtain said illumination parameter.
